(19) United States
(12) Patent Application Publication
(10) Pub. No.: US 2008/0062686 A1
(43) Pub. Date: Mar. 13, 2008

(54) Illumination System

(75) Inventors: Christoph Gerard August Hoelen, Eindhoven (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,517

(22) PCT Filed: Aug. 18, 2005
(86) PCT No.: PCT/IB05/52721

§ 371 Date: Mar. 19, 2007

(30) Foreign Application Priority Data
Sep. 24, 2004 (EP) 04104640.0

(51) Int. Cl. G02B 27/30; G02B 5/02

(52) U.S. Cl. 362/240

(57) ABSTRACT

An illumination system has a plurality of light emitters (R, G, B), at least one light-collimating section (12, 12′, 12″) for collimating the light emitted by the light emitters arranged along a longitudinal axis (25) of the illumination system. The at least one lightcollimating sections merge into a light-mixing section (3) at a side facing away from the light emitters. The light-mixing section has a plurality of side-faces parallel to the longitudinal axis. A surface of the light-mixing section facing away from the light emitters is provided with a light-shaping diffuser (17). Preferably, the light-shaping diffuser is a holographic diffuser. Preferably, the illumination system comprises a plurality of light-collimating sections each of the light-collimating sections being associated with at least one light emitter. The illumination system provides improved spatial and spatio-angular mixing of the light emitted by the light emitters.

The invention relates to an illumination system comprising a plurality of light-collimating sections and a light-mixing section.

Such illumination systems are known per se. They are used, inter alia, as backlighting of (image) display devices, for example for television receivers and monitors. Such illumination systems can particularly suitably be used as a backlight for non-emissive displays, such as liquid crystal display devices, also referred to as LCD panels, which are used in (portable) computers or (cordless) telephones. Another application area of the illumination system according to the invention is the use as illumination source in a digital projector or so-called beamer for projecting images or displaying a television program, a film, a video program or a DVD, or the like. In addition, such illumination systems are used for general lighting purposes, such as spot lights, accent lighting, flood lights and for large-area direct-view light emitting panels such as applied, for instance, in signage, contour lighting, and billboards. In other applications, the light emitted by such illumination systems is fed into a light guide, optical fiber or other beam-shaping optics.

Generally, such illumination systems comprise a multiplicity of light emitters, for instance light-emitting diodes (LEDs). LEDs can be light sources of distinct primary colors, such as, for example the well-known red (R), green (G), or blue (B) light emitters. In addition, the light emitter can have, for example, amber, magenta or cyan as primary color. These primary colors may be either generated directly by the light-emitting-diode chip, or may be generated by a phosphor upon irradiance with light from the light-emitting-diode chip. In the latter case, also mixed colors or white light is possible as one of the primary colors. Generally, the light emitted by the light emitters is mixed in the transparent element(s) to obtain a uniform distribution of the light while eliminating the correlation of the light emitted by the illumination system to a specific light emitter. In addition, it is known to employ a controller with a sensor and some feedback algorithm in order to obtain high color accuracy.

The English translation of Japanese patent application JP-A 2002-133 932 describes an illumination system comprising a light-guide member comprising three light-emitting diodes (LEDs) of different primary colors. In the known illumination system, the light is mixed such that the light emitted by the illumination system is substantially white. The light-guide member comprises three recessed portions for accommodating housing for the respective LEDs. In the known illumination system, side surfaces of the light-guide member are formed into curved surfaces and the light-guide member is provided at a side facing away from the LEDs with an exit surface from which the light emitted by the LEDs is emitted. At the exit surface of the light-guide member, the light-guide member is provided with a diffusion layer for diffusing the light exiting from the exit surface. The known illumination system is constructed such that when light emission failure occurs at any of the three LEDs, that LED can be replaced to restore the white light emitting function.

A drawback of the known illumination system is that the light emitted by the illumination system is not sufficiently uniform.

The invention has for its object to eliminate the above disadvantage wholly or partly. According to the invention, this object is achieved by an illumination system comprising:

a plurality of light emitters,

at least one light-collimating section for collimating the light emitted by the light emitters,

the at least one light-collimating section being arranged along a longitudinal axis of the illumination system,

the at least one light-collimating section merging into a light-mixing section at a side facing away from the light emitters,

the light-mixing section having a plurality of side-faces parallel to the longitudinal axis,

a surface of the light-mixing section facing away from the light emitters being provided with a light-shaping diffuser.

According to the invention, the illumination system comprises a light-collimating section, a light-mixing section and a light-shaping diffuser. The combination of these three elements of the illumination system provides a substantially uniform distribution of light emitted by the illumination system according to the invention. Depending on the dimensions of the illumination system, the light emitted by the illumination system is substantially mixed in a spatial as well as in an angular manner. In addition, the light emitted by the illumination system is substantially collimated (paralleled).

Preferably, the light-shaping diffuser is a holographic diffuser. A favorable embodiment of the light-shaping diffuser is a randomized holographic diffuser. The primary effect of the holographic diffuser is that a uniform spatial and angular light distribution and color distribution is obtained. By the nature of the holographic diffuser, the dimensions of the holographic diffuser, or beam shaper, are so small that no details are projected on a target, thus resulting in a spatially and/or angularly smoothly varying, homogeneous beam pattern. A secondary effect of a holographic diffuser is the causing of a change in the shape of the light beam emitted by the illumination system. Preferably, the diffuser is integrated with the dielectric body of the light-mixing section and located at the exit window of the light-mixing section.

The optics of the illumination system comprises the at least one light-collimating section for collimating the light emitted by the light emitters, the light-mixing section for mixing the light emitted by the at least one light-collimating section and the light-shaping diffuser. Preferably, the illumination system comprises a plurality of light-collimating sections arranged substantially parallel to each other along the longitudinal axis of the illumination system, each of the light-collimating sections being associated with at least one light emitter. Each of the light-collimating sections is either associated with a single light emitter or with a cluster of light emitters. A cluster of light emitters is either a group of light emitters with the same primary color or of a mix of primary colors.

In addition, by providing the light-mixing section with a plurality of (substantially flat) side-faces arranged parallel to the longitudinal axis, spatial mixing of the light emitted by the light emitters is stimulated. If the light-mixing section is provided with a substantially circular outer surface, this would be unfavorable for the spatial mixing of the light emitted by the light emitters. Preferably, the light-mixing section is provided with four or six side-faces. It was found that such a preferred number of side-faces stimulates spatial and spatio-angular mixing of the light emitted by the light emitters.

Light in the light-collimating sections may propagate in various manners. In one preferred embodiment light propagation in the light-collimating sections is based on total internal reflection. By basing the propagation of light emitted by the light emitters on total internal reflection (TIR), light losses in the light-collimating section are largely avoided. In such an embodiment, the light-collimating sections are, preferably, made of a non-gaseous, optically transparent dielectric material with a refractive index larger than or equal to 1.3. In another embodiment, (internal) surfaces of the light-collimating sections are provided with a reflective material. In such an embodiment, the light-collimating sections are, preferably, filled with air.

A preferred embodiment of the illumination system according to the invention is characterized in that the at least one light-collimating section comprises a non-gaseous dielectric or non-gaseous dielectric-filled light-collimating section and wherein the ratio of a length l_{c} of the at least one light-collimating section parallel to the longitudinal axis and a diameter d_{c} of the light-collimating section is in the range:

$$0.35 \leq \frac{{l}_{c}}{{d}_{c}} \leq 2.$$

Values of l_{c}/d_{c} larger than 2 are feasible, but the dimensions of the light-collimating section would become impractical or the spatial and/or angular mixing in the light-mixing section would become inefficient. Values of l_{c}/d_{c} smaller than 0.35 are also feasible, but the efficiency of the system would be relatively low.

Light in the light-mixing section may propagate in various manners. In one preferred embodiment light propagation in the light-mixing section is based on total internal reflection. In such an embodiment, the light-mixing section is, preferably, made of a non-gaseous, optically transparent dielectric material with a refractive index larger than or equal to 1.3. In another embodiment, (internal) surfaces of the light-mixing section are provided with a reflective material. In such an embodiment, the light-mixing section is, preferably, filled with air.

A preferred embodiment of the illumination system according to the invention is characterized in that the light-collimating sections and the light-mixing section form one integral part. By avoiding interface surfaces between the light-collimating sections and the light-mixing section, the efficiency of light propagation in the illumination system according to the invention is enhanced. In addition, by forming the light-collimating sections and the light-mixing section into one single dielectric portion, so-called Fresnel reflection losses at interfaces are avoided.

The uniformity of the light emitted by the illumination system is further improved by dimensioning the light-mixing section in a favorable manner. To this end a preferred embodiment of the illumination system according to the invention is characterized in that the ratio of a length lₘₛ of a non-gaseous dielectric-filled light-mixing section parallel to the longitudinal axis and a diameter dₘₛ of this light-mixing section is in the range:

$$3.5 \leq \frac{{l}_{m s}}{{d}_{m s}} \leq 10.$$

Values of lₘₛ/dₘₛ larger than 10 are feasible, but the dimensions of the light-mixing section would become impractical. Values of lₘₛ/dₘₛ smaller than 3.5 are also feasible, but the spatial and/or angular mixing of the light emitted by the illumination system are relatively limited at such low values.

Another preferred embodiment of the illumination system according to the invention is characterized in that the ratio of a length lₘₛ of an air-filled light-mixing section parallel to the longitudinal axis and a diameter dₘₛ of this light-mixing section is in the range:

$$2 \leq \frac{{l}_{m s}}{{d}_{m s}} \leq 7.$$

Values of lₘₛ/dₘₛ larger than 7 are feasible, but the dimensions of the light-mixing section would become impractical or reflection losses become unacceptable. Values of lₘₛ/dₘₛ smaller than 2 are also feasible, but the spatial and/or angular mixing of the light emitted by the illumination system are relatively limited at such low values.

The collimation of the light emitted by the illumination system can be further improved by providing additional means for collimating the light emitted by the light emitters. To this end a preferred embodiment of the illumination system according to the invention is characterized in that the light-mixing section at a side facing away from the light emitters is provided with a further light-collimating section. This further light-collimating section further collimates the beam of light emitted by the light-mixing section.

There are various ways to realize the further light-collimating section. In a first embodiment, the further light-collimating section comprises a conical shape broadening from the light-mixing section. In a further embodiment, the further light-collimating section is facetted for further enhancing the homogenization of the light beam emitted by the illumination system. In yet a further embodiment, the further light-collimating section is substantially shaped according to a compound parabolic concentrator (CPC). Combinations of the embodiments of the further light-collimating sections are possible.

These and other aspects of the invention are apparent from and will be elucidated with reference to the embodiments described hereinafter.

In the drawings:

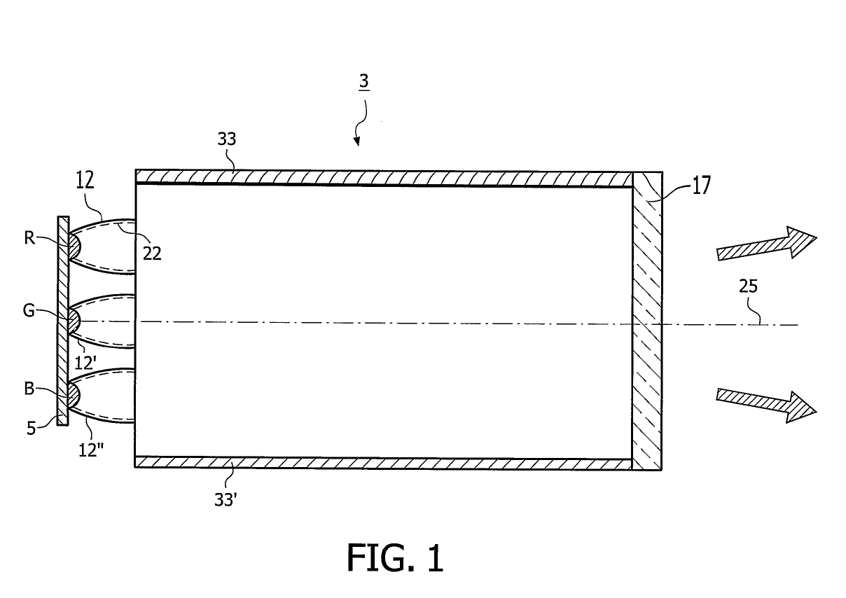

FIG. 1 is a cross-sectional view of a first embodiment of the illumination system according to the invention;

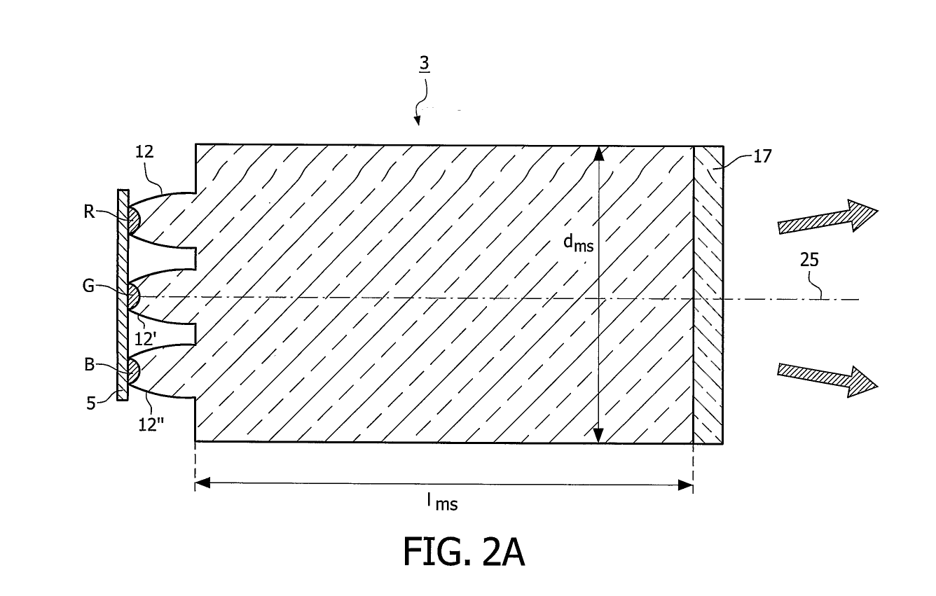

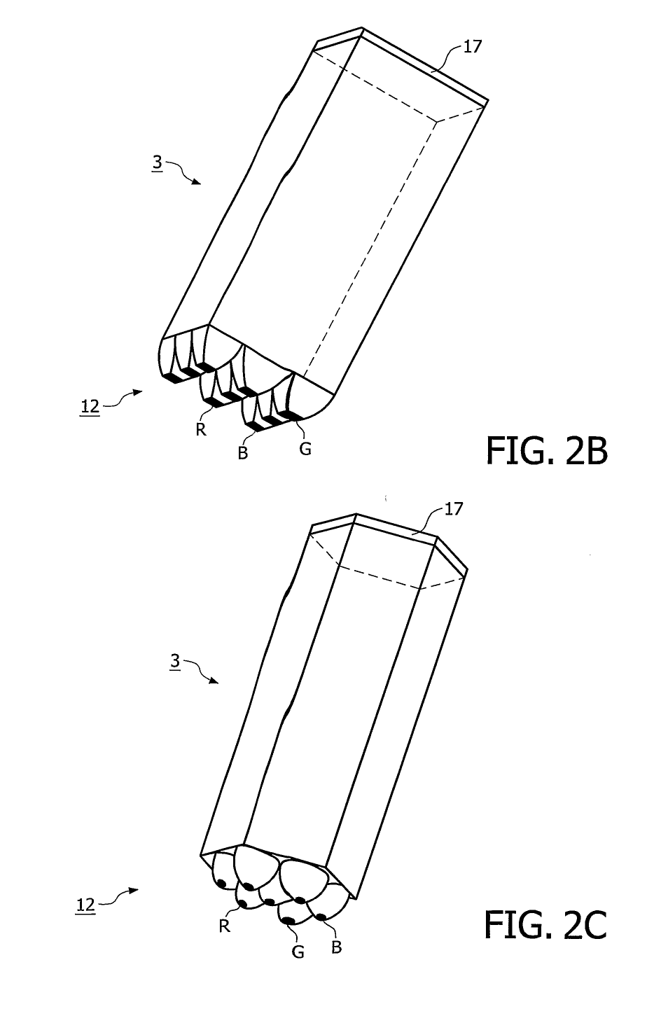

FIG. 2A is a cross-sectional view of a second embodiment of the illumination system according to the invention;

FIG. 2B and 2C are perspective views of two alternative embodiments of the light-collimating section and the light-mixing section of the illumination system as shown in FIG. 2A;

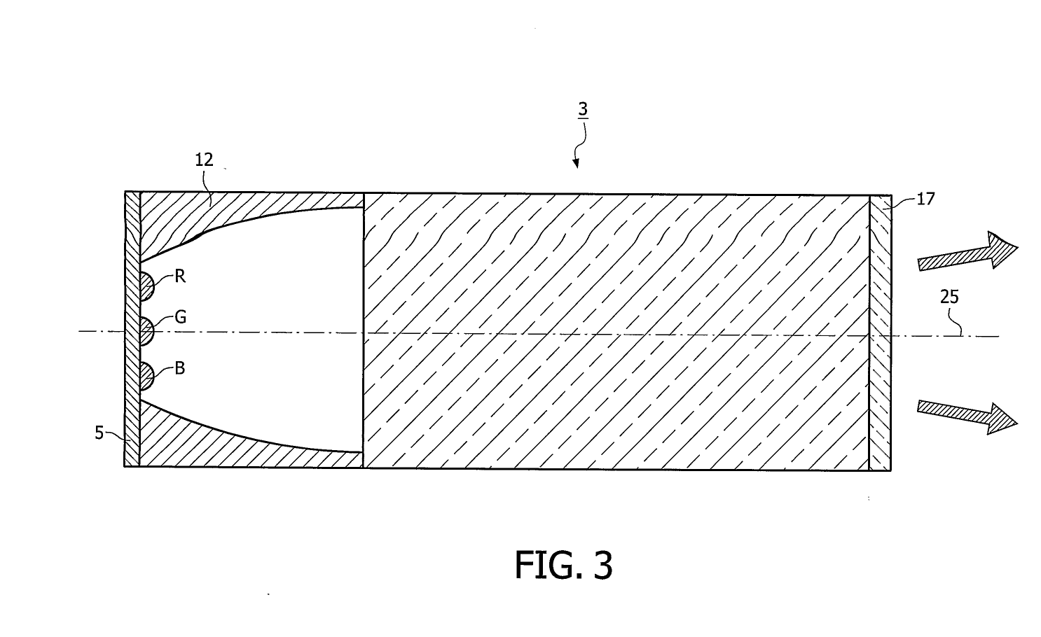

FIG. 3 is a cross-sectional view of a third embodiment of the illumination system according to the invention, and

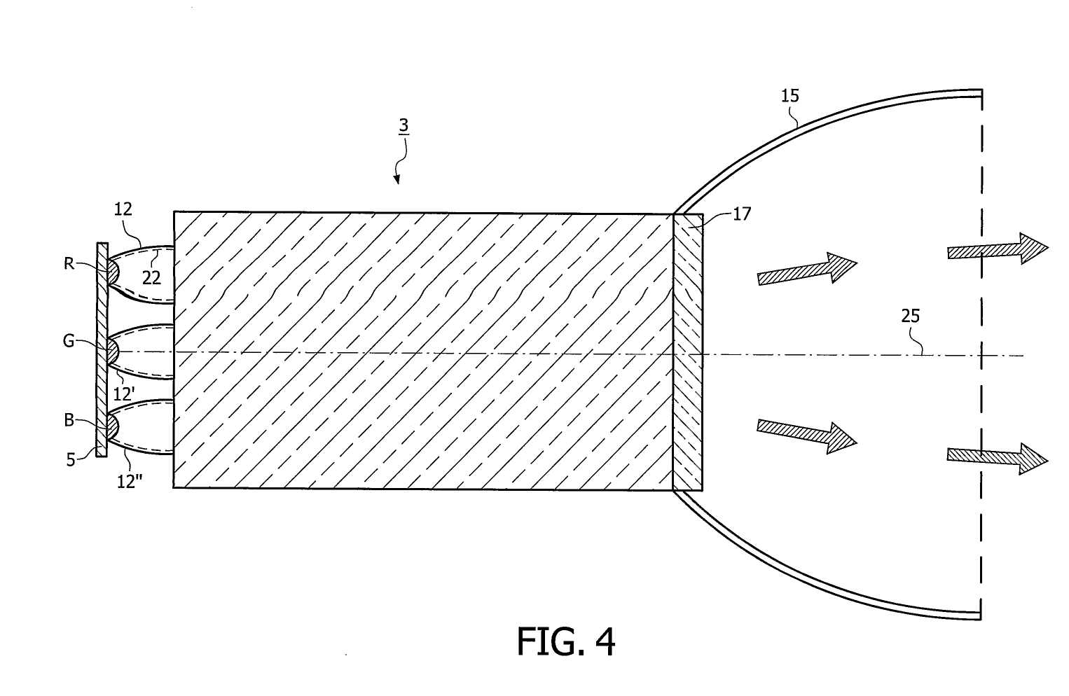

FIG. 4 is a cross-sectional view of a fourth embodiment of the illumination system according to the invention.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1 very schematically shows a cross-sectional view of a first embodiment of the illumination system according to the invention. The illumination system comprises a plurality of light emitters R, G, B, for instance a plurality of light-emitting diodes (LEDs). LEDs can be light emitters of distinct primary colors, such as in the example of FIG. 1, the well-known red R, green G, or blue B light emitters. Alternatively, the light emitter can have, for example, amber, magenta or cyan as primary color. The primary colors may be either generated directly by the light-emitting-diode chip, or may be generated by a phosphor upon irradiance with light from the light-emitting-diode chip. In the latter case, also mixed colors or white light is possible as one of the primary colors. In the example of FIG. 1, the LEDs R, G, B are mounted on a (metal-core) printed circuit board 5. In general, LEDs have relatively high source brightness. Preferably, each of the LEDs has a radiant power output of at least 25 mW when driven at nominal power and at room temperature of the LED junction generating the light. LEDs having such a high output are also referred to as LED power packages. The use of such high-efficiency, high-output LEDs has the specific advantage that, at a desired, comparatively high light output, the number of LEDs may be comparatively small. This has a positive effect on the compactness and the efficiency of the illumination system to be manufactured. If LED power packages are mounted on such a (metal-core) printed circuit board 5, the heat generated by the LEDs can be readily dissipated by heat conduction via the PCB. In a favorable embodiment of the illumination system, the (metal-core) printed circuit board 5 is in contact with a housing (not shown in FIG. 1) of the illumination system via a heat-conducting connection. Preferably, so-called naked-power LED chips are mounted on a substrate, such as for instance an insulated metal substrate, a silicon substrate, a ceramic or a composite substrate. The substrate provides electrical connection to the chip and acts as well as a good heat transportation section to transfer heat to a heat exchanger.

The embodiment of the illumination system as shown in FIG. 1 comprises a plurality of light-collimating sections 12, 12′, 12″, a light-mixing section 3 and a light-shaping diffuser 17. The light-collimating sections 12, 12′, 12″ are arranged substantially parallel to each other along a longitudinal axis 25 of the illumination system. More precisely, the sections each have an axis of rotation symmetry, which axes are arranged substantially parallel to each other and to longitudinal axis 25. Each of the light-collimating sections 12, 12′, 12″ is associated with at least one light emitter R, G, B. In the example of FIG. 1 a single LED is associated with each respective light-collimating section. In an alternative embodiment there are more LEDs associated with each respective light-collimating section. This may be either a number of the LEDs with the same primary color or a number of LEDs with two or more primary colors.

In the example of FIG. 1, the light-collimating sections 12, 12′, 12″ are filled with air. Light propagation in the light-collimating sections 12, 12′, 12″ is based on reflection on reflective surfaces 22 on sidewalls of the light-collimating sections 12, 12′, 12″. The light-collimating sections 12, 12′, 12″ at an exit surface at a side facing away from the light emitters R, G, B merge into the light-mixing section 3. In the example of FIG. 1, the light-mixing section 3 is filled with air. Light propagation in the light-mixing section 3 is based on reflection on (specular) reflective surfaces 33, 33′ on sidewalls of the light-mixing section 3. The sidewalls of the light-mixing section 3 may be reflective themselves or may be provided with a reflective coating applied, preferably, at an inner surface of the sidewalls. In addition, a surface of the light-mixing section 3 facing away from the light emitters R, G, B is provided with a light-shaping diffuser 17, in the example of FIG. 1 a holographic diffuser. The primary effect of the holographic diffuser is promoting spatial and angular mixing of the color distribution and the light distribution of the light emitted by the illumination system.

The combination of the plurality of light-collimating sections 12, 12′, 12″, the light-mixing section 3 and the light-shaping diffuser 17 in the illumination system according to the invention provides a substantially uniform distribution of light emitted by the illumination system. Depending on the dimensions of the illumination system, the light emitted by the illumination system is substantially mixed in a spatial as well as in an angular manner. In addition, the light emitted by the illumination system is substantially collimated, i.e. the light emitted by the illumination system is substantially paralleled (see the broad arrows in FIG. 1).

FIG. 2A schematically shows a cross-sectional view of a second embodiment of the illumination system according to the invention. The illumination system comprises a plurality of light emitters R, G, B, mounted on a (metal-core) printed circuit board 5. In the example of FIG. 2A, the light-collimating sections 12, 12′, 12″ and the light-mixing section 3 are made of a non-gaseous, optically transparent dielectric material. Preferably, the dielectric material has a refractive index larger than or equal to 1.3. In the embodiment of the illumination system as shown in FIG. 2A, the plurality 2 of the light-collimating sections 12, 12′, 12″ and the light-mixing section 3 form a single integral part. To this end the light-collimating sections 12, 12′, 12″ merge into the light-mixing section 3 at a side facing away from the light emitters R, G, B. By avoiding interface surfaces between the light-collimating sections 12, 12′, 12″ and the light-mixing section 3, the efficiency of light propagation in the illumination system according to the invention is largely enhanced. By forming the light-collimating sections 12, 12′, 12″ and the light-mixing section 3 into one single dielectric piece of material, so-called Fresnel reflection losses at interfaces are largely avoided.

Light propagation in the light-mixing section 3 of the illumination system as shown in FIG. 2A is based on total internal reflection (TIR) whereby light losses in the light-mixing section 3 are largely avoided. In addition, the light-mixing section 3 comprises a plurality of side-faces parallel to the longitudinal axis 25, thereby stimulating spatial and angular mixing of the light emitted by the light emitters R, G, B. If the light-mixing section 3 is provided with a substantially circular outer surface, spatial mixing of the light emitted by the light emitters would not be stimulated enough. Preferably, the light-mixing section 3 is provided with four or six side-faces parallel to the optical axis. Such a number of side-faces provides excellent spatial and spatio-angular mixing of the light emitted by the light emitters.

Preferably, the light-collimating sections 12, 12′, 12″ and the light-mixing section 3 are made from one piece of an acrylic material or from glass. Preferably, the light-collimating sections 12, 12′, 12″ are moulded directly on and around the light emitters, or an encapsulant is provided between the light emitters R, G, B and the respective light-collimating sections 12, 12′, 12″. The embodiment of the illumination system as shown in FIG. 2A has an improved system efficiency due to a practically loss-less total internal reflection in the light-collimating section and the light-mixing section. In addition, due to the light-collimating sections 12, 12′, 12″ and the light-mixing section 3 being formed as one single dielectric body, interfaces are reduced that would lead to unwanted loss of light and a reduced efficiency of the illumination system. By reducing the number of optical parts and because the complete optics are made as a single injection moulded component, the illumination system according to the embodiment of the illumination system shown in FIG. 2A is cost-effective.

Part of an outer surface of the light-collimating sections 12, 12′, 12″ may be made reflective or may be provided with a reflective layer (not shown in FIG. 2A) that is in direct contact with the dielectric of the light-collimating sections 12, 12′, 12″ or that is provided as a separate component not in direct contact with the light-collimating sections 12, 12′, 12″ such that a first part of the light is reflected by total internal reflection and a second part which is transmitted by the light-mixing section is reflected by the external reflector. In FIG. 2A, light propagation in the light-collimating sections 12, 12′, 12″ is promoted by basing light propagation in the light-collimating sections 12, 12′, 12″ on total internal reflection (TIR). This avoids any losses due to reflections and is the favorable mechanism for reflecting the light during propagation through the light collimating and light-mixing sections. However, providing part of each of the light-collimating sections with a reflective layer enables smaller pitches between the light-collimating sections, i.e., a more dense packing of the light sources, and thus reduces the overall size of the system significantly. In such an embodiment, preferably the light-collimating sections at least partly are designed as a so-called compound parabolic concentrator (CPC). Preferably, the collimation of the light in the light-collimating sections is limited to that angles of propagation relative to the optical axis such that these light rays just stay within the regime of total internal reflection when interacting with the side walls of the light-mixing section. In this manner the length of the light-mixing section required for a certain degree of homogenization is minimized, enabling minimum overall system dimensions. In an alternative embodiment, the shape of the light-collimating sections is similar to but not exactly the shape of a compound parabolic concentrator.

A preferred embodiment of the illumination system according to the invention is characterized in that the at least one light-collimating section 12, 12′, 12″ comprises a non-gaseous dielectric or non-gaseous dielectric-filled light-collimating section 12, 12′, 12″ and wherein the ratio of a length l_{c} of the at least one light-collimating section 12, 12′, 12″ parallel to the longitudinal axis and a diameter d_{c} of the light-collimating section 12, 12′, 12″ is in the range:

$$0.35 \leq \frac{{l}_{c}}{{d}_{c}} \leq 2.$$

Mixing of light in the light-mixing section 3 is promoted if the dimensions of the light-mixing section 3 are suitable chosen. Preferably, the ratio of a length lₘₛ of a non-gaseous dielectric-filled light-mixing section 3 measured parallel to the longitudinal axis 25 and a characteristic dimension of the thickness of the light-mixing section 3, addressed as the diameter dₘₛ of the light-mixing section 3 is in the range:

$$3.5 \leq \frac{{l}_{m s}}{{d}_{m s}} \leq 10.$$

A very suitable value for the ratio lₘₛ/dₘₛ of the non-gaseous dielectric-filled light-mixing section 3 is approximately 5.

Another preferred embodiment of the illumination system according to the invention is characterized in that the ratio of a length lₘₛ of an air-filled light-mixing section 3 parallel to the longitudinal axis and a diameter dₘₛ of this light-mixing section 3 is in the range:

$$2 \leq \frac{{l}_{m s}}{{d}_{m s}} \leq 7.$$

A very suitable value for the ratio lₘₛ/dₘₛ of the air-filled light-mixing section 3 is approximately 3.3.

FIG. 2B and FIG. 2C are perspective views of two alternative embodiments of the light-collimating section and the light-mixing section of the illumination system as shown in FIG. 2A. FIG. 2B shows an embodiment of the light-collimating sections 12 and the light-mixing section 3 wherein the light-mixing section 3 comprises four side-faces. FIG. 2C shows an embodiment of the light-collimating sections 12 and the light-mixing section 3 wherein the light-mixing section 3 comprises six side-faces. In FIGS. 2B and 2C, the light-collimating section 12 and the light-mixing section 3 are made from a single piece of dielectric material. The light-emitters R, G, B are indicated very schematically in FIGS. 2B and 2C. In addition, a surface of the light-mixing section 3 in FIG. 2B and 2C facing away from the light emitters R, G, B are provided with a light-shaping diffuser 17, in the example of FIGS. 2B and 2C, a holographic diffuser.

FIG. 3 schematically shows a cross-sectional view of a third embodiment of the illumination system according to the invention. The illumination system comprises a single light-collimating section 12 provided with a plurality of light emitters R, G, B, mounted on a (metal-core) printed circuit board 5. In the example of FIG. 3, the light-mixing section 3 is made of a non-gaseous, optically transparent dielectric material. The light-mixing section 3 comprises a plurality of side-faces parallel to the longitudinal axis 25, thereby promoting spatial and spatio-angular mixing of the light emitted by the light emitters R, G, B (see FIGS. 2B and 2C).

FIG. 4 schematically shows a cross-sectional view of a fourth embodiment of the illumination system according to the invention. The illumination system comprises a plurality of light emitters R, G, B, mounted on a (metal-core) printed circuit board 5. In the example of FIG. 4, the light-collimating sections 12, 12′, 12″ are filled with air. Light propagation in the light-collimating sections 12, 12′, 12″ is based on reflection on reflective surfaces 22 on sidewalls of the light-collimating sections 12, 12′, 12″. The light-collimating sections 12, 12′, 12″ at an exit surface at a side facing away from the light emitters R, G, B merge into the light-mixing section 3. In the example of FIG. 4, the light-mixing section 3 is made of a non-gaseous, optically transparent dielectric material, preferably, with a refractive index larger than or equal to 1.3. In the embodiment of the illumination system as shown in FIG. 4, the light-mixing section 3 at a side facing away from the light emitters R, G, B is provided with a further light-collimating section 15 for collimating the light emitted by the light emitters R, G, B. By providing the further light-collimating section 15, the collimation of the light emitted by the illumination system is further improved. In addition, the further light-collimating section 15 effectively further collimates the beam of light emitted by the illumination system to the desired numerical aperture of an additional optical system (see the broad arrows in FIG. 4). In the example of FIG. 2, the further light-collimating section 15 comprises a conical shape broadening from the light-mixing section 3. In addition or alternatively, the further light-collimating section 15 is facetted and/or the further light-collimating section 15 is substantially shaped according to a compound parabolic concentrator. In addition or alternatively to the light-shaping diffuser located at the side of the light-mixing section facing away from the light emitters, a light-shaping diffuser is provided at the exit window of the further light-collimating section 15 of the illumination system. Preferably, this light-shaping diffuser is a holographic diffuser.

Normally LEDs radiate according to a complete hemisphere or more. Using lenses to collimate the light from such relatively small light emitters implies that only a relatively small part of the light generated is effectively used. An almost perfectly efficient collimator is the so-called Compound Parabolic Concentrator (CPC) or significantly similar collimator. Because the LED surface does, generally, not uniformly radiate, and because different colored LEDs may be used, an extra homogenization step is necessary. A light mixing section (sometimes also called an integrating rod) on top the light-collimating section is one of the options to achieve this with respect to spatial mixing. The CPC and the light mixing section can be combined into one (plastic) component. It is advantageous to use two CPCs as compared to one CPC in case the light should be further collimated. In such a configuration, the light mixing section is situated between both CPCs. Because the beam is collimated just sufficiently for efficient homogenization in a small light mixing section, the device becomes significantly smaller. Preferably, the second CPC collimates the beam to the desired numerical aperture of a subsequent optical system. However, the angular and/or spatio-angular mixing can be further improved by applying a diffuser in the light emitting system that takes care of the small-angle mixing of the light. It is particularly favorable to locate this diffuser at a position where the light is already mixed spatially well, such as at the exit window of the light mixing section or at the exit window of the further light mixing section.

A surface of the light-mixing section 3 in FIG. 4 facing away from the light emitters R, G, B is provided with a light-shaping diffuser 17, in the example of FIG. 4, a holographic diffuser. In an alternative embodiment the light-shaping diffuser is provided on an exit window of the further light-collimating section 15.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising:
a plurality of light emitters (R, G, B),
at least one light-collimating section (12, 12′, 12″) for collimating the light emitted by the light emitters (R, G, B),
the at least one light-collimating section (12, 12′, 12″) being arranged along a longitudinal axis (25) of the illumination system,
the at least one light-collimating section (12, 12′, 12″) merging into a light-mixing section (3) at a side facing away from the light emitters (R, G, B),
the light-mixing section (3) having a plurality of side-faces parallel to the longitudinal axis (25),
a surface of the light-mixing section (3) facing away from the light emitters (R, G, B) being provided with a light-shaping diffuser (17).

2. An illumination system as claimed in claim 1, wherein the illumination system comprises a plurality of light-collimating sections (12, 12′, 12″) arranged substantially parallel to each other along the longitudinal axis (25) of the illumination system, each of the light-collimating sections (12, 12′, 12″) being associated with at least one light emitter (R, G, B).

3. An illumination system as claimed in claim 2, wherein light propagation in the light-collimating sections (12, 12′, 12″) is based on total internal reflection or on reflection on reflective surfaces (22) of the light-collimating sections (12, 12′, 12″).

4. An illumination system as claimed in claim 1, wherein the at least one light-collimating section (12, 12′, 12″) comprises a non-gaseous dielectric or non-gaseous dielectric-filled light-collimating section (12, 12′, 12″) and wherein the ratio of a length l of the at least one light-collimating section (12, 12′, 12″) parallel to the longitudinal axis and a diameter d_{c} of the light-collimating section (12, 12′, 12″) is in the range:
$$0.35 \leq \frac{{l}_{c}}{{d}_{c}} \leq 2.$$

5. An illumination system as claimed in claim 1, wherein light propagation in the light-mixing section (3) is based on total internal reflection or on reflection on reflective surfaces (33, 33′) of the light-mixing section (3).

6. An illumination system as claimed in claim 2, wherein the light-collimating sections (12, 12′, 12″) and the light-mixing section (3) form one integral part (1).

7. An illumination system as claimed in claim 6, wherein the light-collimating sections (12, 12′, 12″) and the light-mixing section (3) are made from a dielectric material with a refractive index larger than or equal to 1.3.

8. An illumination system as claimed in claim 1, wherein the light-mixing section (3) comprises a non-gaseous dielectric or non-gaseous dielectric-filled light-mixing section (3) and wherein the ratio of a length lₘₛ of the light-mixing section (3) parallel to the longitudinal axis (25) and a diameter dₘₛ of the light-mixing section (3) is in the range:
$$3.5 \leq \frac{{l}_{m s}}{{d}_{m s}} \leq 10.$$

9. An illumination system as claimed in claim 1, wherein the light-mixing section (3) comprises an air-filled light-mixing section (3) and wherein the ratio of a length lₘₛ of the light-mixing section (3) parallel to the longitudinal axis (25) and a diameter dₘₛ of the light-mixing section (3) is in the range:
$$2 \leq \frac{{l}_{m s}}{{d}_{m s}} \leq 7.$$

10. An illumination system as claimed in claim 1, wherein the light-mixing section (3) is provided with four or six side-faces.

11. An illumination system as claimed in claim 1, wherein the light-shaping diffuser (17) is a holographic diffuser.

12. An illumination system as claimed in claim 1, wherein the light-mixing section (3) at a side facing away from the light emitters (R, G, B) is provided with a further light-collimating section (15).

13. An illumination system as claimed in claim 12, wherein the further light-collimating section (15) is substantially shaped according to a compound parabolic concentrator.

14. An illumination system as claimed in claim 1, wherein the light emitters comprise at least a first light-emitting diode (R) of a first primary color, at least a second light-emitting diode (G) of a second primary color, and at least a third light-emitting diode (B) of a third primary color, the three primary colors being distinct from each other.

15. An illumination system as claimed in claim 14, wherein each of the light-emitting diodes (R, G, B) has a radiant power output of at least 25 mW when driven at nominal power and with the light-generating junction of the light emitting diodes (R, G, B) at room temperature.
